(19) United States
(12) Patent Application Publication
(10) Pub. No.: US 2006/0076952 A9
(43) Pub. Date: Apr. 13, 2006

(54) Segmented field sensors

(75) Inventors: Neil J. Goldfine, Newton, MA (US); Darrell E. Schlicker, Watertown, MA (US); David C. Grundy, Reading, MA (US); Mark D. Windoloski, Burlington, MA (US); Ian C. Shay, Waltham, MA (US); Andrew P. Washabaugh, Chula Vista, CA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: JENTEK Sensors, Inc., Waltham, MA (US)

(21) Appl. No.: 11/056,334

(22) Filed: Feb. 11, 2005

Related U.S. Application Data
(60) Provisional application No. 60/543,876, filed on Feb. 12, 2004.
(60) Provisional application No. 60/550,147, filed on Mar. 4, 2004.

(51) Int. Cl. G01N 27/82

(52) U.S. Cl. 324/240

(57) ABSTRACT

Apparatus and methods are described for assessing material condition through magnetic field measurements that provide material property information at multiple depths into the material. The measurements are obtained from sense elements located at different distances from an excitation drive winding, with the area of each sense element adjusted so that the flux of magnetic field through each sense element is approximately the same when over a reference material. These sense element responses can be combined, for example by subtraction, to enhance sensitivity to hidden features, such as cracks beneath fastener heads, while reducing the influence from variable effects, such as fastener material type and placement. Measurement responses can also be converted into effective material properties, using a model that accounts for known properties of the sensor and test material, which are then correlated with the size of the surface breaking or hidden features.

### RELATED APPLICATION(S)

This application claims the benefit of U.S. Provisional Application Nos. 60/543,867 filed Feb. 12, 2004, and 60/550,147 filed Mar. 4, 2004, the entire teachings of which are incorporated herein by reference.

### BACKGROUND OF THE INVENTION

The technical field of this invention is that of nondestructive materials characterization, particularly quantitative, model-based characterization of surface, near-surface, and bulk material condition for flat and curved parts or components. Characterization of bulk material condition includes (1) measurement of changes in material state, i.e., degradation/damage caused by fatigue damage, creep damage, thermal exposure, or plastic deformation; (2) assessment of residual stresses and applied loads; and (3) assessment of processing-related conditions, for example from aggressive grinding, shot peening, roll burnishing, thermal-spray coating, welding or heat treatment. It also includes measurements characterizing material, such as alloy type, and material states, such as porosity and temperature. Characterization of surface and near-surface conditions includes measurements of surface roughness, displacement or changes in relative position, coating thickness, temperature and coating condition. Each of these includes detection of electromagnetic property changes associated with either microstructural and/or compositional changes, or electronic structure (e.g., Fermi surface) or magnetic structure (e.g., domain orientation) changes, or with single or multiple cracks, cracks or stress variations in magnitude, orientation or distribution.

A common technique for material characterization is eddy-current testing. Conventional eddy-current sensing involves the excitation of a conducting winding, the primary, with an electric current source of prescribed frequency. This produces a time-varying magnetic field, which in turn is detected with a sensing winding, the secondary. The spatial distribution of the magnetic field and the field measured by the secondary is influenced by the proximity and physical properties (electrical conductivity and magnetic permeability) of nearby materials. When the sensor is intentionally placed in close proximity to a test material, the physical properties of the material can be deduced from measurements of the impedance between the primary and secondary windings. In some cases, only the self-impedance of the primary winding is measured. Traditionally, scanning of eddy-current sensors across the material surface is then used to detect features, such as cracks.

In many inspection applications, large surface areas of a material need to be tested. This inspection can be accomplished with a single sensor and a two-dimensional scanner over the material surface. However, use of a single sensor has disadvantages in that the scanning can take an excessively long time and care must be taken when registering the measured values together to form a map or image of the properties. These shortcomings can be overcome by using an array of sensors, but each sensor must be driven sequentially in order to prevent cross-talk or cross-contamination between the sensors. An example is given in U.S. Pat. No. 5,047,719, which discloses the use of a flexible sensor arrays and a multiplexer circuit for measuring a response in the vicinity of each individual array element. Another example is given in U.S. Pat. No. 3,875,502 which discloses a single rectangular drive coil and multiple sense coils, including offset rows of sensing elements for complete coverage when scanned over a surface in a direction perpendicular to the longest segments of the drive coil. The sense coils are oriented in the vertical direction so that only the horizontal component of the magnetic flux is detected and measurement signal is non-negligible only when the sensor array is passed over a local anomaly. U.S. Pat. No. 5,793,206 provides another array example in which multiple sense elements are placed within a single sensor drive footprint. With known positions between each array element, the material can be scanned in a shorter period of time and the measured responses from each array element are spatially correlated.

In other inspection applications, there is a need to detect hidden flaws, such as cracks that form beneath fasteners, which means beneath the fastener head, nut, or washers used in the fastened joint. Often, the critical crack size for the structural element containing the fastener is small enough that the crack must be detected before it propagates from beneath the head or nut of the fastener. When the head is flush with the surface of the test material, sliding eddy current probes are commonly used in which the differential response between two coils is measured as the probe is scanned over the fastener. For protruding fastener heads or nuts, other electromagnetic techniques can be used which measure the response from a coil placed over the fastener, as described for example in U.S. Pat. No. 4,271,393, or from a coil mounted beneath a fastener head, as described for example in British Patent 886,247. Typically, the measured response is then compared to the response obtained on a reference sample with a fastener that contains a flaw of known size and has material properties and geometry that match the test material.

### SUMMARY OF THE INVENTION

Aspects of the methods described herein involve nondestructive condition monitoring of materials. These methods include sensor designs that permit measurements at multiple interrogating field penetration depths without varying the excitation frequency for the measurement. Example interrogating fields include magnetic and electric fields.

In one embodiment, a sensor has a drive winding for imposing a magnetic field in a test material when driven by an electric current and multiple sense elements for measuring a response of the test material. At least two of the sense elements are located at different distances from the drive winding so that each responds to different segments or components of the magnetic field that couples into the test material. The size of the sense elements is adjusted or designed so that the net magnetic flux passing through each of these sense elements located at different distances to the drive winding is essentially the same. The magnetic flux is generally only the same for a single reference material. In embodiments, the reference material is air or a material having uniform electrical properties, such as the electrical conductivity or the magnetic permeability. In yet another embodiment, a sense element is a loop of conducting segments for linking the magnetic flux. In another, multiple sense elements are located at one distance to the drive winding to create an array of sense elements. This facilitates the imaging of properties when scanned over a material.

In an embodiment, a sensor having a drive winding and multiple sense elements, at least two of which are placed at different distances to the drive winding, are placed next to a test material and the response from sense elements at different distances to the drive winding are combined to provide information about a material condition. The areas of the sense elements are adjusted or designed so that the sense elements link the same net flux of magnetic field. In embodiments, the sense elements are inductive coils or a sense element includes a giant magnetoresistive sensor. The sensor may be attached or mounted to the material surface or it can be scanned over the surface. In one embodiment, the combination is performed by subtracting the response. In another, the combination is performed by taking a ratio of the responses. In yet another embodiment, the sense element responses are converted into effective material properties, such as electrical conductivity, magnetic permeability, or layer thickness, prior to being combined together. In an embodiment, the test material includes a fastener and the material condition assessment is to determine the presence or size or a feature, such as a crack. A magnet may also be placed over the fastener to reduce the influence of the fastener properties on the measurement. In another embodiment, the material condition, such as disbonding, is monitored during mechanical loading so that changes in material properties can be tracked as damage or usage progresses. An example material is a graphite fiber composite.

In another embodiment, features in a material are detected and characterized by placing a sensor near a test material, converting the sensor response into an effective property using a model that incorporates information about the sensor geometry and baseline test material properties, and correlating this effective property with the presence or size of the feature of interest. The baseline or unflawed material properties, such as the electrical conductivity, the magnetic permeability, or a layer thickness, may be obtained as part of the inspection procedure or prior to inspection on a material that is similar or representative of the test material. In one embodiment, the effective property is the complex magnetic permeability and the information about the electrical conductivity and layer thicknesses are incorporated into the model calculation. In another embodiment, the feature is a crack. In yet another embodiment, the conversion of the sense element response into an effective property uses a precomputed database of model responses.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a drawing of an eddy current sensor having two rows of sense elements.

FIG. 2 shows a drawing of an eddy current sensor having three rows of sense elements.

FIG. 3 shows a representative measurement grid relating the magnitude and phase of the sensor terminal impedance to the lift-off and magnetic permeability.

FIG. 4 shows a representative measurement grid relating the magnitude and phase of the sensor terminal impedance to the lift-off and electrical conductivity.

FIG. 5 shows a layout for a single turn Cartesian geometry GMR magnetomer.

FIG. 6 is a plot of the calculated response to a surface breaking notch using a model. Only the response to the secondary element on the left side of the central conductor is indicated.

FIG. 7 shows a schematic diagram for the magnetic field around a fastener for the sensor of FIG. 2.

FIG. 8 shows a schematic diagram for the scanning of a segmented field sensor over a fastener.

FIG. 9 shows a representative measurement grid relating the magnitude and phase of the sensor terminal impedance to the effective complex permeability of a test material.

FIG. 10 shows a plot of a typical signature response scan over a steel fastener at 6.3 kHz with no notch under the fastener head.

FIG. 11 shows a plot of a response versus EDM notch size for first-layer notches under steel fastener heads.

FIG. 12 shows a plot of a simulated signal to noise ratio for a flaw beneath a steel fastener for thin aluminum layers, with the fastener at select locations and a magnet behind the sensor.

FIG. 13 shows a plot of a simulated signal to noise ratio for a flaw beneath a steel fastener for thick titanium layers, with the fastener at select locations and a magnet behind the sensor.

FIG. 14 shows a schematic diagram of a segmented field sensor placed over a composite joint.

### DETAILED DESCRIPTION OF THE INVENTION

A description of preferred embodiments of the invention follows.

The design and use of conformable eddy current sensor arrays that provide information at multiple spatial wavelengths or penetration depths is described for the nondestructive characterization of materials. This is accomplished by placing sense elements at different distances to a drive winding and adjusting the sizes or dimensions of the sense elements so that the approximate magnitude of the responses for each sense element is the same. This simplifies measurement of the sense element response since similar or identical instrumentation can be used for each sense element. This is also useful for sensor arrays having at least one linear array of sense elements at a single distance from the drive winding. These linear arrays are well suited to inspections over wide areas as a single scan allows the material properties to be determined over a relatively wide distance. Also, sequential scans can be concatenated, with or without overlap, to create images over wide areas. Furthermore, simple manual scans can be used with only a roller encoder to record position, still producing two-dimensional images of the quality previously achieved with high cost automated scanners. Measurements of the responses from each element in a linear array of sensing elements, oriented perpendicular to the scan direction, also facilitates the creation of material property images so that the presence of property variations or defects are readily apparent. The additional information gained from the sense elements placed at a second, third, or higher distance from the drive winding provides additional information that can be used to characterize the material.

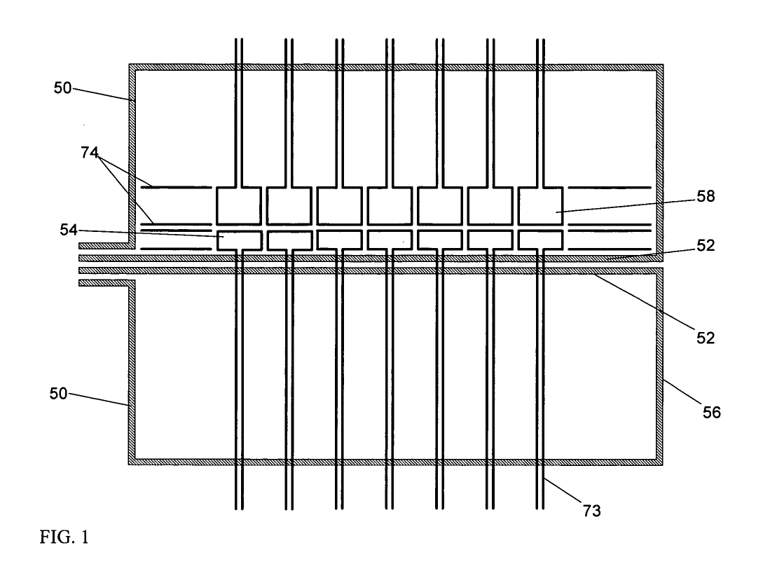

In one embodiment, eddy current sensor arrays containing one or more parallel linear drive windings and multiple sensing elements are used to inspect a test material. An example sensor array is shown in FIG. 1. This array includes rectangular loops 50 the serve as drive windings and create a magnetic field when driven by an electric current. The loops have extended portions 52 and a plurality of secondary elements 54 which, in this case, are parallel to the extended portions. The secondary elements 54 sense the response of the material under test (MUT) to the imposed magnetic field. A time-varying current is applied to the primary winding, which creates a magnetic field that penetrates into the MUT and induces a voltage at the terminals of the secondary elements. This terminal voltage reflects the properties of the MUT. The secondary elements are pulled back from the connecting portions of the primary winding 56 to minimize end effect coupling of the magnetic field. However, the sense elements can be brought close to the connecting portions 56 if space is limited for the inspection. Dummy elements 74 can be placed between the meanders of the primary to maintain the symmetry or uniformity of the magnetic field, as described in U.S. Pat. No. 6,188,218.

In FIG. 1, one row of secondary elements 54 is close to the central drive winding portions 52 while another row of secondary elements 58 is further away. Since the magnetic field intensity decreases with distance away from the drive windings, the magnetic field is weaker over the area spanned by each element in the distant row of elements. The dimensions, size or area of the elements in the distant row 58 are made larger than the elements in the near row 54 so that the nominal magnetic flux linked by the elements in each row is comparable. In determining the size of the elements, the flux linkage can be compared when the reference material is air or some other material having known uniform properties. A model for the field intensity variation, either analytical, quasi-analytical, or numerical, is typically used to determine the appropriate sense element size. This allows the same electrical impedance measurement instrumentation to be used for both sets of sensing elements so that customized instrumentation is not required. Note the use of sensing elements at different distances to the drive winding for sensing different components of the magnetic field distribution are described in U.S. patent application Ser. Nos. 10/102,620 filed Mar. 19, 2002, and 10/155,887, filed May 23, 2002, the entire teachings of which are incorporated herein by reference, but adjusting the sense elements to have similar magnetic flux or impedance magnitudes are not described in that application. The leads 73 to the secondary elements can be simple conductors placed close together to minimize stray coupling or they can be in a flux canceling configuration that essentially cancels any parasitic flux coupled to the leads, as described in U.S. patent application Ser. Nos. 09/666,879 and 09/666,524, both filed on Sep. 20, 2000, the entire teachings of which are incorporated herein by reference. In FIG. 1, the drive winding loops 50 are placed in a different plane than the leads 73 and separated by an insulating layer. The secondary loops (54 and 58) are typically in the same plane as the leads 73.

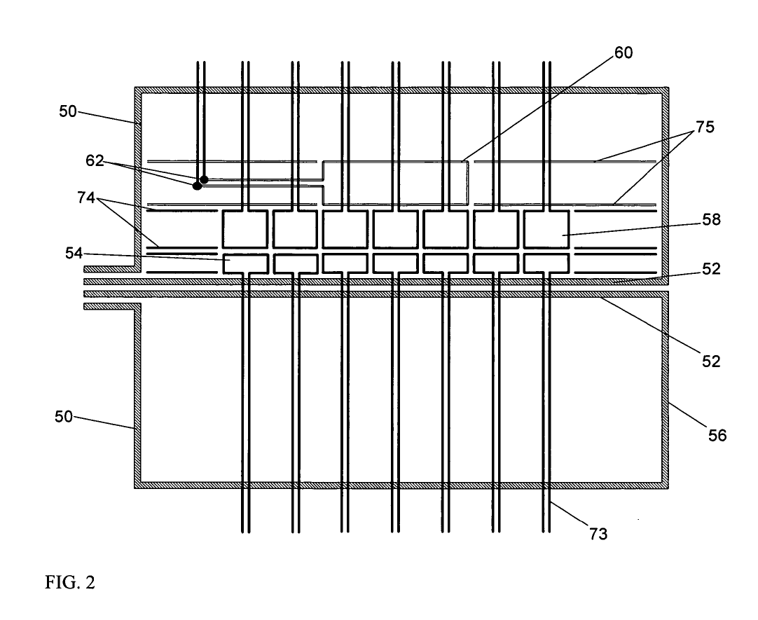

Another embodiment is shown in FIG. 2. In this case, a third sense element 60 is positioned even further from the central portions of the drive winding 52 than the other secondary elements (54 and 58). Again, the area of the secondary element 60 is larger than the areas of the other secondary elements so that the magnetic flux linked is approximately the same. The sense element 60 is in the same plane as the drive winding loops 50 while the electrical leads that pass over the drive winding loop are in the same plane as the leads to the sense elements 54 and 58. Interconnections are then made to conductors in the plane of sense element 60 through vias 62. Dummy elements 75 are also used to help reduce end effects on the element response. While these descriptions have focused on drive windings having a linear conducting segment or containing one or more rectangular loops, other drive winding configurations can also be used with sense elements at different distances to the drive windings, such as circular, elliptical, or spiral windings.

An efficient method for converting the response of the sensor into material or geometric properties is to use grid measurement methods. These methods map two known values, such as the magnitude and phase or real and imaginary parts of the sensor impedance, into the properties to be determined. The measurement grids are two-dimensional databases that can be visualized as “grids” that relate two measured parameters to two unknowns, such as the magnetic permeability (or electrical conductivity) and lift-off (where lift-off is defined as the proximity of the MUT to the plane of the sensor windings). For the characterization of coatings or surface layer properties, three- (or more)-dimensional versions of the measurement grids called lattices and hypercubes, respectively, can be used. Alternatively, the surface layer parameters can be determined from numerical algorithms that minimize the least-squares error between the measurements and the predicted responses from the sensor, or by intelligent interpolation search methods within the grids, lattices or hypercubes.

An advantage of the measurement grid method is that it allows for near real-time measurements of the absolute electrical properties of the material and geometric parameters of interest. The database of the sensor responses can be generated prior to the data acquisition on the part itself, so that only table lookup and interpolation operations, which are relatively fast, needs to be performed after measurement data is acquired. Furthermore, grids can be generated for the individual elements in an array so that each individual element can be lift-off compensated to provide absolute property measurements, such as the electrical conductivity. This again reduces the need for extensive calibration standards. In contrast, conventional eddy-current methods that use empirical correlation tables that relate the amplitude and phase of a lift-off compensated signal to parameters or properties of interest, such as crack size or hardness, require extensive calibrations using standards and instrument preparation.

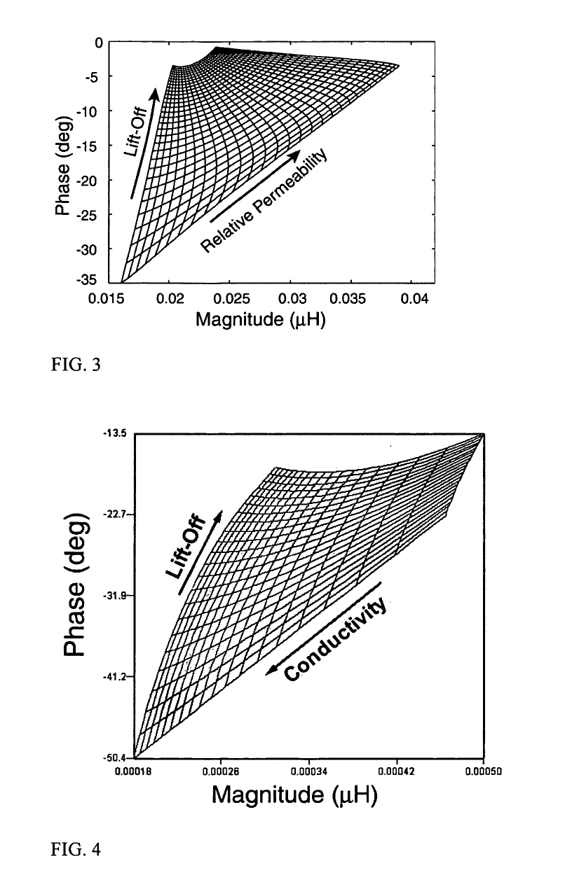

For ferromagnetic materials, such as most steels, a measurement grid can provide a conversion of raw data to magnetic permeability and lift-off. A representative measurement grid for ferromagnetic materials is illustrated in FIG. 3. A representative measurement grid for a low-conductivity nonmagnetic alloy (e.g., titanium alloys, some superalloys, and austenitic stainless steels) is illustrated in FIG. 4. For coated materials, such as cadmium and cadmium alloys on steels, the properties of the coatings can be incorporated into the model response for the sensor so that the measurement grid accurately reflects, for example, the permeability variations of substrate material with stress and the lift-off. Lattices and hypercubes can be used to include variations in coating properties (thickness, conductivity, permeability), over the imaging region of interest. The variation in the coating can be corrected at each point in the image to improve the measurement of permeability in the substrate for the purpose of imaging stresses. The effective property can also be a layer thickness, which is particularly suitable for coated systems. The effective property could also be some other estimated damage state, such as the dimension of a flaw or some indication of thermal damage for the material condition.

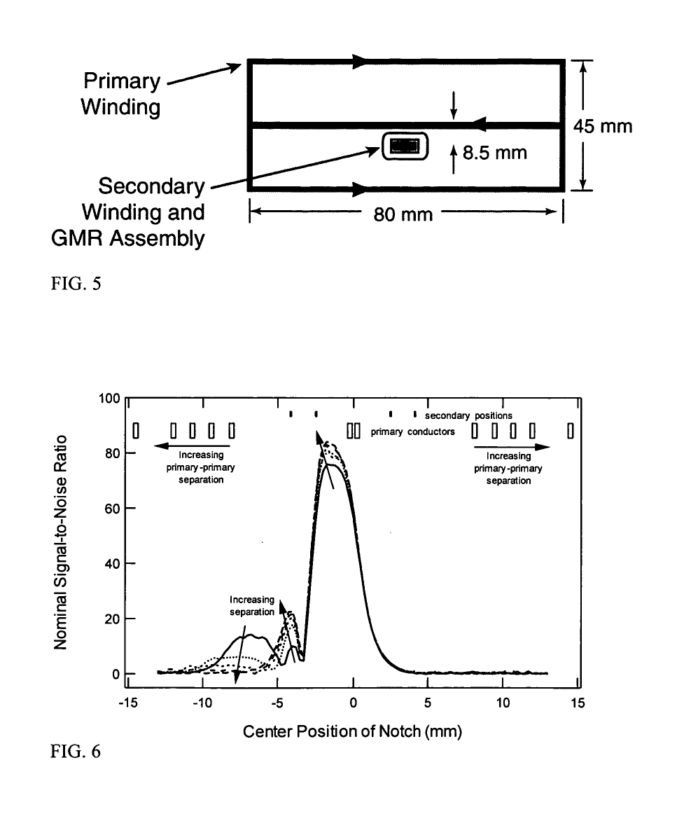

In addition to inductive coils, other types of sensing elements, such as Hall effect sensors, magnetoresistive sensors, SQUIDS, Barkhausen noise sensors, and giant magnetoresistive (GMR) devices, can also be used for the measurements. The use of GMR sensors for characterization of materials is described in more detail in U.S. patent application Ser. No. 10/045,650, filed Nov. 8, 2001, the entire teachings of which are incorporated herein by reference. FIG. 5 shows a drive winding with a sense element incorporating a GMR sensor. Conventional eddy-current sensors are effective at examining near surface properties of materials but have a limited capability to examine deep material property variations. GMR sensors respond to magnetic fields directly, rather than through an induced response on sensing coils, which permits operation at low frequencies, even DC, and deeper penetration of the magnetic fields into the test material. The GMR sensors can be used in place of sensing coils, conventional eddy-current drive coils, or sensor arrays. Thus, the GMR-based sensors can be considered an extension of conventional eddy-current technology that provides a greater depth of sensitivity to hidden features and are not deleteriously affected by the presence of hidden air gaps or delaminations.

Placing the secondary elements at different locations compared to the drive winding allows different segments or components of the magnetic field that have different penetration depths into the MUT to be measured. These magnetic field components and the vector potential produced by the current in the primary can be accurately modeled as a Fourier series summation of spatial sinusoids. The current through the adjacent extended portions 52 of the drive winding loops of FIG. 1 is in the same direction. The resulting local magnetic field in the vicinity of the sense elements approximates the spatially periodic field pattern of meandering winding geometries, described for example in U.S. Pat. Nos. 5,015,951, 5,453,689, 5,793,206, 6,188,218, and Re. 36,986. The dominant spatial mode for these periodic sensors has a spatial wavelength λ, which corresponds to the dimension of spatial periodicity. Higher order modes have a shorter characteristic length or spatial wavelength.

The depth of penetration of the magnetic field into the MUT depends upon the excitation frequency, the electrical properties of the MUT, and the sensor or sensor array geometry. The electrical properties, such as the electrical conductivity σ and magnetic permeability μ, can be combined with the excitation frequency to form the conventional skin depth δ=(πfμσ)^{-1/2}. This is the characteristic length for magnetic field penetration into the MUT if sensor geometry effects can be neglected. It decreases as the frequency, conductivity, or permeability increases. When the geometric effects of the sensor are included, the penetration depth d can be expressed as d=1/ [symbol] (\sqrt{(2π/λₙ)²+2j/δ²}) where [symbol] denotes the real part, λₙ gives the spatial wavelength for the field mode and j=\sqrt{−1}. Thus, while both the skin depth and the spatial wavelength affect the penetration depth, the smaller of the two typically determines the penetration depth for the field. This shows that both the excitation frequency and the spatial wavelength can change the penetration depth so that measurements can be performed at multiple penetration depths to provide complementary information about the MUT properties. However, if the material properties also vary with frequency, such as for a dispersive material, then varying the frequency is of limited use and varying the spatial wavelength becomes valuable.

The size of the drive winding loops and the distances between the drive winding segments and the sense elements can be adjusted or selected based on the sensitivity to the material condition of interest. The use of the multiple rows of sense elements at different distances to the drive are particularly useful for the detection of subsurface damage or the characterization of geometric features such as inclusions or cracks. Inspection examples include the detection and characterization of cracks under fastener heads or in lower skin layers and corrosion under paint or fastener heads. An example of this type of simulation to determine sensitivity to a hidden crack is described in U.S. patent application Ser. No. 10/102,620. For example, FIG. 6 shows the results for a model calculation as a sensor is scanned over a flaw for several different distances to the return leg of the drive winding. The response is expressed in terms of a signal to noise ratio (SNR) between flawed and unflawed material scans. There is a large indication when the flaw is between the central drive winding segments and the sensing element. There is also a significant peak in the response when the flaw is nearly beneath the return leg of the drive winding and a minor peak above the outer conductor for the secondary winding. As the drive winding separation distance is increased, the primary peak increases slightly and the peak associated with the return leg of the drive is reduced. This is often desirable because a larger signal is obtained from the flaw and the reduction in the distant peak helps to reduce the appearance of “ghost” signals in scan images. The minor peak above the outer conductor for the secondary winding is also enhanced as the drive winding separation distance is increased so that more of the signal is concentrated in the vicinity of the sensing secondary element, which again reduces the “ghosting” effect.

Similar calculations can be performed for optimizing the distances between the sense elements and the drive winding. By adjusting these distances, the observability of or sensitivity to a material condition or a particular feature of the MUT can be enhanced. The material condition can be a usage state, such as the material temperature or stress, which can be determined from a measurement of the material properties, such as the electrical conductivity, magnetic permeability, or a layer thickness. Alternatively, the material condition may be whether or not a feature or an object is present. Enhancing observability to the material condition and features in the material also has implications for the usage and maintenance or components, as described in U.S. patent application Ser. No. 10/763,573 filed Jan. 22, 2004, the entire teachings of which are incorporated herein by reference.

The responses from the sense elements coupling to different segments or spatial wavelengths of the magnetic field distribution can also be combined to enhance observability of a particular feature of the MUT. As an example, consider FIG. 7 which shows a schematic diagram of the magnetic field in the vicinity of a crack underneath a fastener head along with a cross-sectional view of the sensor of FIG. 2. Since the fastener may have significantly different electrical properties than the material layers (for example a steel fastener in an aluminum or titanium skin) varying the frequency will also vary the response from the fastener so simple frequency subtraction would not be adequate. Instead, a segmented field sensor can be used. The sense elements “near” the central portions of the drive winding respond to short spatial wavelength modes and, in this case, do not see the crack under the fastener head. The “middle” sense elements respond to intermediate spatial wavelengths and see the crack under the fastener head. The outermost sense element “far” from the drive windings responds to longer spatial modes and to material properties deeper than the crack. This indicates that subtracting the “near” response, which is sensitive to the fastener properties, from the “middle” response, which is sensitive to both the fastener and crack properties, would allow the crack response to be separated from the fastener response. A similar approach can be used for deeper cracks on other surfaces.

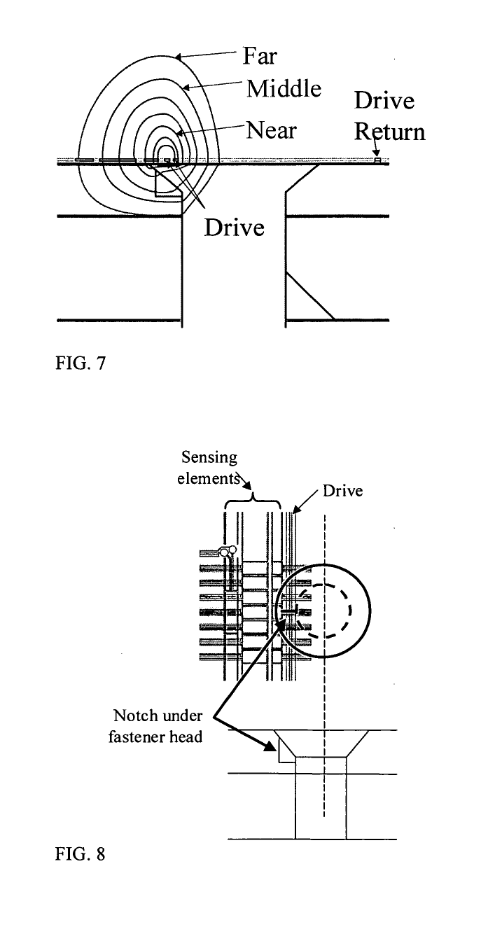

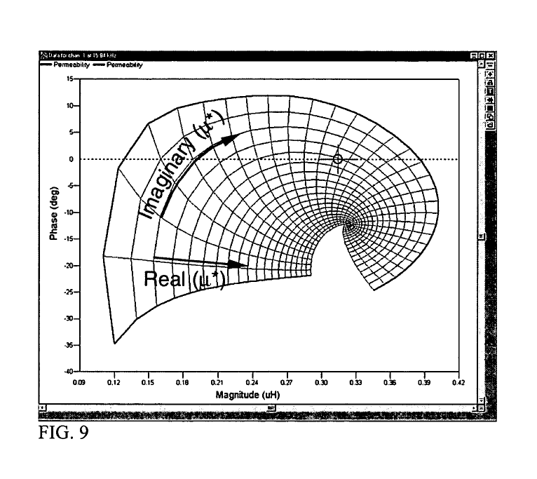

FIG. 8 shows a schematic diagram for scanning of the sensor array of FIG. 2 over a fastener. In this case a crack or notch is located in the first layer underneath the fastener head. In this orientation, the sensor is most sensitive to the crack when the drive is approximately over the crack but the middle and far sense elements are not yet over the fastener. The sensor is less sensitive to the crack location when the crack is on the opposite side of the fastener from the scan location. Several approaches were used to detect these cracks.

In one measurement set, the samples were composed of two 0.040 in. thick aluminum sheets that were overlapped approximately 3 in. and secured together with three rows of aluminum rivets at 1 in. centers. The panels were also painted, and on one of the panels the paint was removed along the fastener row of interest. Prior to riveting, cracks were put in the first layer, which were obscured fully or partially by the head of the rivet. Initially, multiple frequency measurements were initially performed and the responses subtracted to determine a characteristic flaw shape that could be used in a filter for the flaw response. This is basically the approach used to detect third layer cracks in aluminum lapjoints as described in U.S. patent application Ser. No. 10/102,620. However, this multiple frequency approach for the first layer cracks was relatively sensitive to the fastener response.

A second approach was to use a single measurement frequency and an effective medium model for the crack response. Here, scans were taken using the sensor of FIG. 1 at 15.8 kHz. Since the cracks were located in the first layer, the sense elements nearest the central drive windings were used. The measurement procedure involved calibrating the sensor array using air and shunt measurements. The data was then processed using complex permeability (μ*) measurement grids. This involved first determining the base conductivity of the aluminum test material (32%IACS) and the nominal lift-off of the sense elements (0.0039-in.). A model for the sensor response then used this information to calculate a measurement grid over a range of values for the effective real and imaginary parts of the complex permeability. An example layered media model, which also accounts for finite winding thickness, is described in U.S. patent Ser. No. 10/963,482 filed Oct. 12, 2004, the entire teachings of which are incorporated herein by reference. Note that over an unflawed area, and distant from a fastener, the real part of the complex permeability is one and the imaginary part of the complex permeability is zero. This provides a technique for incorporating into the measurement as much deterministic information about the test material as possible. FIG. 8 shows a representative measurement grid for the real and imaginary parts of the complex magnetic permeability. This grid could also be expressed in terms of the complex magnetic susceptibility.

For these materials, the effective permeability varies over each fastener due to the differences in material properties and interactions between the fastener and the surrounding materials. The crack appears as a reduced response on the side of the fastener. In this case, a threshold was selected to maximize sensitivity to the smaller flaws while minimizing the number of false calls. In practice, this threshold would be set prior to performing an inspection on a component and should be based on a rigorous probability of detection and false call analysis. This approach met the desired inspection crack size requirement for this application. The only false calls occurred due to assignable causes, being at locations that had a crack on the other side of the fastener or on the nearby side from an adjacent fastener, and are not considered true false calls since they are not independent of related events.

In another sample set, the fastener properties were significantly different than the skin properties and another approach was used. In this set, the sample was composed of two aluminum plates, with the top layer 0.25 in. thick and the bottom layer 0.375 in. thick. Six 0.25 in. dia. holes were drilled through the plates at 1 in. centers along centerline of plates, and the top layer was countersunk to dimensions appropriate for some typical steel fasteners. EDM notches of various sizes were milled into the first layer holes. These notches spanned the countersink and land regions of holes and extended less than the width of the steel fastener head.

Measurement scans were then performed on the sample using the sensor of FIG. 2. A key feature of this sensor is that there are three rows of sensing elements at different distances from the primary winding. By combining the response data from the different elements, cracks under the fastener heads can be detected. It was observed that there was some variation in the depth of the countersink in the actual sample. Some of the holes were countersunk slightly deeper so that the fastener head was somewhat recessed below the surface of the sample. This introduced variability in the sensor response and can affect the measurement results. This type of variability in the countersink and even the fastener properties is accounted for with the sensor of FIG. 2 and combining the response data from elements placed at different distances to the drive winding.

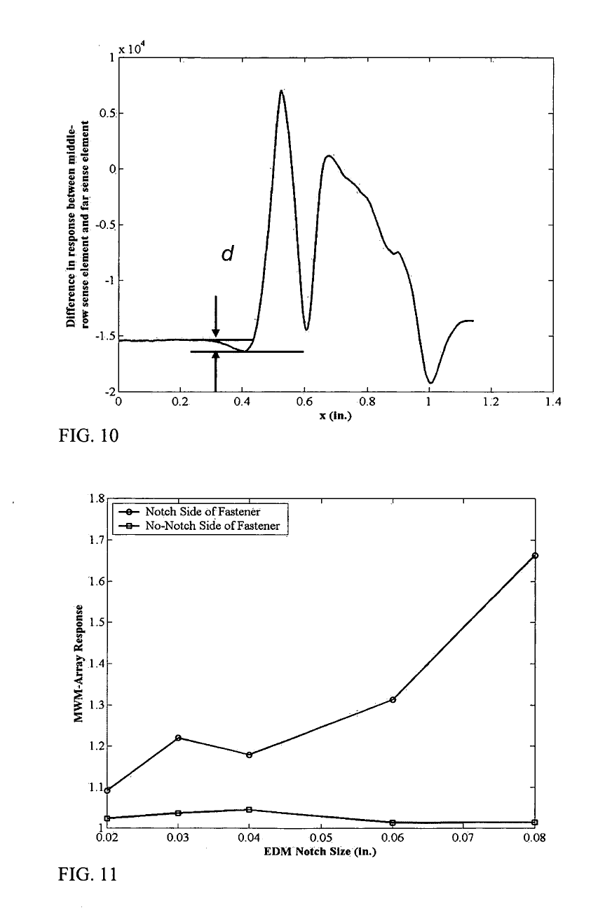

The sensor of FIG. 2 reduces the effects of the variability of the fastener response by measuring the material response at multiple depths for the same excitation frequency. FIG. 10 shows a typical response from a 6.3 kHz scan over a steel fastener with no notch. The net response is obtained by subtracting the response of the element farthest from the central drive windings, which has the deepest depth of sensitivity, from the response of a sense element in the middle row. The first minimum in the signature response is sensitive to the presence of an EDM notch under the fastener head. The other peaks and valleys are associated with the fastener response itself. In this case, the characteristic response d is defined as shown in FIG. 10. The sensor response for a given notch is then defined by d/d₀ where d₀ is the average value of d from repeat scans of fasteners with no EDM notch.

FIG. 11 is a plot of the sensor response value vs. notch size. The response depends on how the sensor is oriented over the notch, as described with respect to FIG. 8. Each data point represents an average of four measurements. FIG. 11 shows that the response tends to increase with the size of the EDM notch in the first layer underneath the fastener head when the sensor is in the “sensitive” orientation. It also shows that when scanned with the sensor in the “non-sensitive” orientation there is no relationship between notch size and sensor response.

Combining the responses from the different sense elements can be performed in a variety of ways to obtain the net response. In the above example, a subtraction was used between the far and middle sense element responses. The sense element responses can be in the form of the magnitude and/or phase of the terminal impedance, the real and/or imaginary parts of the terminal, or the effective properties that would be obtained by converting the terminal values into effective properties using, for example, measurement grids. Functional forms for comparing these responses include subtraction or ratios of the responses. The segmented field approach could also be combined with the effective complex permeability and multiple frequency approaches to enhance observability to the material condition of interest.

To illustrate the interferences from the steel fastener, including the reduced skin depth and the effect of fastener-to-fastener variations, several finite element method simulations were performed. These simulations were aimed at understanding the effects of varying the properties of steel fasteners on the measurement sensitivity to subsurface cracks beneath the fasteners. A single wavelength sensor array having a wavelength of 1.0 in. was assumed, with sensing elements located on one side of the central conductors of the primary winding. One sense element was “near” the central conductors and the other was “far” from the central conductors of the primary winding.

In order to understand the steel fastener effects for different structural materials (such as titanium and aluminum), simulations were performed for a number of cases. One case considered a titanium alloy structure. In another case, the layer geometry was assumed to be an outer (front) 0.125 in. thick layer over a hidden (back) 0.25 in. thick layer. Both layers had an electrical conductivity of 30%IACS appropriate for an aluminum alloy. The fastener was assumed to be steel with an electrical conductivity of 3.45%IACS and a relative permeability of 40, 10, or 2. An artificial flaw/insulating gap was placed beneath the fastener head in the first layer. The simulated response was calculated for flaw sizes of 0.0001 in. (i.e., no flaw) and 0.080 in. long.

The simulation results are plotted in terms of a signal-to-noise ratio (SNR), which was determined from:

$$SNR = {F}_{X} = \sqrt{{( \frac{{Z}_{r} - {Z}_{ro}}{Δ {Z}_{r}} )}^{2} + {( \frac{{Z}_{i} - {Z}_{io}}{Δ {Z}_{i}} )}^{2}}$$

where Z is the impedance between the drive winding and the sense element, the subscript r denotes the real part, the subscript i denotes the imaginary part, the subscript o denotes the offset or reference response, Δ denotes the noise level, and Fₓ, which is a correction factor, was set to one in this case. The offset is determined from the sense element response when the fastener is far away from the sense element or from a reference scan for the response without a flaw. The noise values were empirically determined.

From these simulations, the difference in properties, both electrical conductivity and magnetic permeability, between the fastener and the material layers leads to a large response when the fastener is beneath the sense elements. Reducing the permeability also reduces the signal response as the permeability of the fastener and aluminum layers become similar. This response changes when a flaw is present under the fastener head. At low frequencies, varying the permeability of the fastener does not have a significant impact on the response to the flaw. In contrast, reducing the magnetic permeability of the fastener has a very large impact on the higher frequency response; at high permeabilities, the response to the flaw is negligible at the higher frequencies but becomes reasonable at the lower permeabilities. This shows that using a magnet or some other means to reduce the magnetic permeability of, or even saturate, the fastener can impact the sensitivity of the measurement to flaws under the fastener head.

Note that the effect of the flaw on the sensor response is much smaller than the response of the fastener itself. This confirms that variations in the fastener properties, possibly associated with the varying stresses on the fastener, will significantly affect the measurement response and may mask the flaw response. This indicates that the major limitation for the inspection of a structure with steel fasteners is not necessarily the depth of sensitivity of the sensor to the flaws, but the effect of fastener to fastener variations. For example, this variability would limit the usefulness of procedures that rely on subtracting a nominal fastener response. In contrast, the segmented field approach, which inherently suppresses such fastener to fastener variations by removing the near-surface fastener interferences at each individual fastener, is more useful.

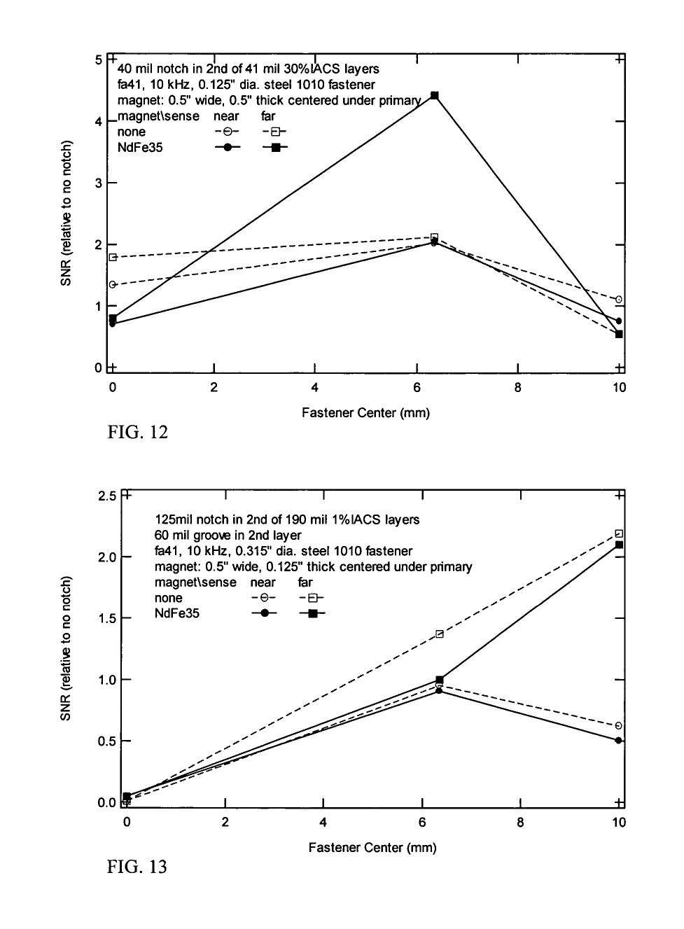

Additional simulations were performed to determine if a magnet placed behind the sensor could provide enough saturation of the steel properties to improve the sensitivity to subsurface flaws. The same sensor was used, but only the response at select locations was calculated. FIG. 12 shows the response for a steel fastener through two 0.041 in. layers having an electrical conductivity of 30%IACS. FIG. 13 shows the response for a larger steel fastener through 1%IACS layers (e.g., titanium alloy), with the first layer 0.190 in. thick, a 0.060 in. air gap, and a 0.160 in. thick second layer. In both cases, the flaw was in the second material layer and the excitation frequency was 10 kHz. FIG. 12 shows that there can be a significant (factor of 2) improvement in the sensitivity at some fastener positions, but in many of the other positions analyzed the magnet did not improve the response.

The example applications provided above were for crack detection underneath fastener heads. However, the segmented field sensor and complex permeability approaches can also be used in other applications where there is a need to remove deterministic variability to enable the inspection. Other representative applications include inspection for hidden corrosion damage, inspection of holes or engine disk slots, and health monitoring where the information can be used to track usage, damage, or damage precursor states.

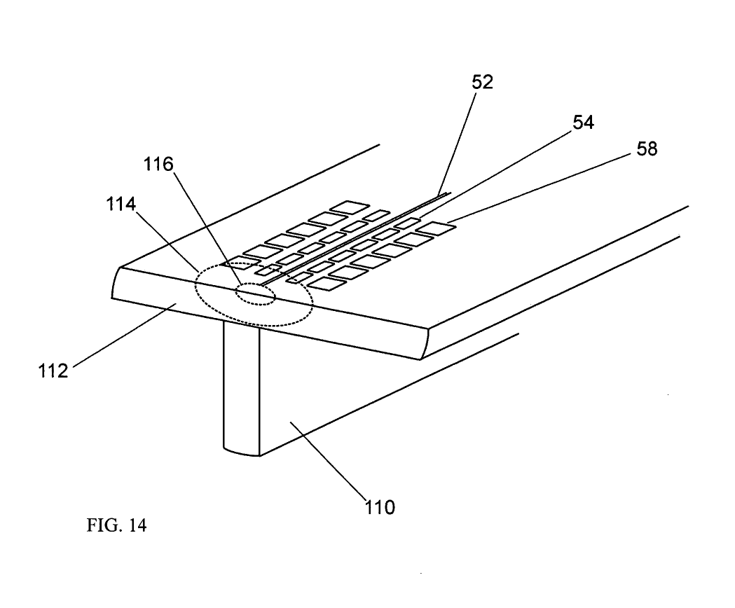

FIG. 14 shows a segmented field sensor for monitoring disbonding in composites. The joint is formed by attaching the support piece 110 to the material layer 112. Typical materials are carbon fiber composites. For monitoring with a magnetic field sensor, the materials must be sufficiently conducting or magnetic to alter the sensing field. FIG. 14 shows a sensor similar to FIG. 1 attached to the surface of the joint, with only the central conductors of the drive winding shown. The “near” sense elements respond to shallow field penetration depths, with the field 116 shown schematically. Similar, the “far” sense elements respond to deeper penetration depths, with the field 114 shown schematically. For monitoring disbonding in the joint, since the disbonds can occur anywhere over the cross-section, the fields for the “far” sense elements should penetrate to the opposite side of the material layer 112. As an alternative, the sensor itself can be scanned over the surface to create images of the material properties. Another alternative is to keep the drive stationary and to move a sensing array over the surface, which would provide information at multiple spatial wavelengths as the distance between the drive and sense elements changes. Furthermore, to enhance sensitivity to any disbonds, a mechanical load can be applied either intentionally or as part of normal behavior. Monitoring of the material could then provide information about any disbonds or other damage, such as changes in the fiber density. Note that the same type of approach can be used with poorly conducting or insulating materials such as fiberglass composites. Then, segmented electric field sensors can be used and the disbonding may be monitored.

While the inventions have been particularly shown and described with reference to preferred embodiments thereof, it will be understood to those skilled in the art that various changes in form and details may be made therein without departing from the spirit and scope of the invention as defined by the appended claims.

What is claimed is:

1. A test circuit comprising:
a drive winding having a conducting segment to impose a magnetic field in a test material when driven by an electric current;
at least two sense elements disposed at different distances to the drive winding, with each sense element providing an output related to the imposed magnetic field; and
the area of each sense element coupling substantially the same magnetic flux when placed near a reference material.

2. The test circuit as claimed in claim 1 wherein the reference material is air.

3. The test circuit as claimed in claim 1 wherein the reference material has uniform electrical properties.

4. The test circuit as claimed in claim 3 wherein the electrical property is electrical conductivity.

5. The test circuit as claimed in claim 3 wherein the electrical property is magnetic permeability.

6. The test circuit as claimed in claim 1 wherein a sense element is a loop of conducting segments.

7. The test circuit as claimed in claim 1 further comprising multiple sense elements located at one distance to the drive winding.

8. The test circuit as claimed in claim 1 wherein the drive winding has a linear conducting segment.

9. The test circuit as claimed in claim 8 wherein the drive winding has a rectangular loop.

10. The test circuit as claimed in claim 1 wherein the drive winding imposes a spatially periodic magnetic field.

11. A method for characterizing a material comprising:
disposing a sensor proximate to a test material surface, the sensor having a drive winding and at least two sense elements, the drive winding having a conducting segment to impose a magnetic field in a test material when driven by an electric current, at least two sense element positioned at different distances to the drive winding, the area of each sense element linking substantially the same amount of magnetic flux;
measuring a response for each sense element; and
combining responses from sense elements at different distances to the drive winding to assess material condition.

12. The method as claimed in claim 11 wherein the sense elements are inductive coils.

13. The method as claimed in claim 11 wherein a sense element has a giant magnetoresistive sensor.

14. The method as claimed in claim 11 further comprising attaching the sensor to the test material surface.

15. The method as claimed in claim 11 further comprising scanning the sensor over the test material surface.

16. The method as claimed in claim 11 wherein combining responses involves subtraction.

17. The method as claimed in claim 11 wherein combining responses involves taking a ratio.

18. The method as claimed in claim 11 further comprising converting the responses into effective material properties.

19. The method as claimed in claim 18 wherein a material property is electrical conductivity.

20. The method as claimed in claim 18 wherein a material property is magnetic permeability.

21. The method as claimed in claim 18 wherein a material property is a layer thickness.

22. The method as claimed in claim 11 wherein the test material includes a fastener.

23. The method as claimed in claim 22 wherein the material condition is crack presence.

24. The method as claimed in claim 22 further comprising placing a magnet over the fastener.

25. The method as claimed in claim 11 further comprising adjusting the distances between the sense elements and drive winding to enhance observability of the material condition.

26. The method as claimed in claim 11 wherein material condition involves detection of an object or feature.

27. The method as claimed in claim 11 wherein material condition is usage state.

28. The method as claimed in claim 11 further comprising measuring sense element responses at multiple excitation frequencies.

29. The method as claimed in claim 11 further comprising monitoring the material condition during mechanical loading of the material.

30. The method as claimed in claim 29 wherein the test material is a graphite fiber composite.

31. The method as claimed in claim 29 wherein the material condition is disbonding.

32. A method for characterizing a feature in a material comprising:
disposing a sensor proximate to a test material surface, the sensor having a drive winding segment to impose a magnetic field in a test material when driven by an electric current and a sense element for sensing properties of the test material;
determining properties of unflawed test material;
measuring a sense element response;
converting the sense element response into an effective property using a model that incorporates sensor geometry and unflawed test material properties; and
using the effective property to characterize the feature.

33. The method as claimed in claim 32 wherein the effective property is complex magnetic permeability.

34. The method as claimed in claim 32 wherein the feature is a crack.

35. The method as claimed in claim 32 wherein characterize indicates feature presence.

36. The method as claimed in claim 32 wherein characterize provides feature size.

37. The method as claimed in claim 32 further comprising using a database of responses to convert the sense element response in an effective property.

38. The method as claimed in claim 32 wherein an unflawed material property is electrical conductivity.

39. The method as claimed in claim 32 wherein an unflawed material property is magnetic permeability.

40. The method as claimed in claim 32 wherein an unflawed material property is a layer thickness.
